(19) United States
(12) Patent Application Publication
(10) Pub. No.: US 2015/0363985 A1
(43) Pub. Date: Dec. 17, 2015

(54) SCANNER PRINTER COMBINATION FOR CREDENTIALING

(71) Applicant: Vendor Credentialing Service LLC (VCS), Houston, TX (US)

(72) Inventor: Garry Wayne Kyle, JR., Flower Mound, TX (US)

(21) Appl. No.: 14/301,675

(22) Filed: Jun. 11, 2014

(51) Int. Cl. G07C 9/00

(52) U.S. Cl. CPC G07C 9/00007

(57) ABSTRACT

A method and apparatus for vendor credentialing. The apparatus includes a printer-scanner combination, which operates by scanning a bar code supplied by the vendor and printing an access indication that—based on the bar code—either permits, denies, or grants conditional vendor access. The vendor acquires the bar code via electronic communications between a mobile electronic device and a credentialing provider and independent of the printer-scanner combination.

### TECHNICAL FIELD

Embodiments of the subject matter disclosed herein generally relate to methods and systems for ensuring that only entities (whether they be persons or things) that meet pre-set criteria are allowed to enter an environment that could be compromised by an entity entering that environment that does not meet the pre-set criteria. In this regard, one embodiment of the present invention is directed to vendor credentialing, where vendors desiring entry to heath care organizations must first meet certain pre-set credentials before being allowed to enter that health care organization's facility.

### DISCUSSION OF THE BACKGROUND

The modern-day explosion in population, disease, harmful substances, dangerous environments, contamination, and crime has given rise to the field of credentialing, which generally concerns taking steps to ensure that people and things are not allowed to go places or encounter things they should not. One example is the health care field. There, a host of environments exist in which it is important that only authorized personnel and/or devices be allowed to interact in proximity to one another. In other words, only personnel and/or a device that meets a common set of pre-established credentials will be allowed to interact within proximity to one another.

As one non-limiting example, take vendors (e.g., service or product providers) who wish to enter a health care facility (e.g., a hospital, doctor's office, or emergency care facility) to sell, service, or otherwise offer their third-party offerings to the operators of the health care facility. In the past, these individuals may have been allowed to enter the facility uninterrupted, without any admittance criteria or standards. The health and safety risks associated with such uninhibited or “free” access are obvious and, as such, now often are prohibited by Federal, state, local, or best practices guidelines.

As referenced above, the process of controlling vendor access to facilities is called credentialing. In the health care environment, one method of credentialing requires vendors to approach a designated screening representative at each health care facility the vendor visits, so that the screening representative can invoke that facility's established protocol for deciding whether to allow the vendor access to the facility. This method is disfavored due to its burden on personnel, necessary training, consequential front-office congestion, lack of contemporaneous access to updated and/or accurate vendor data, and the costs associated therewith.

Another credentialing option is for the health care facility to use the services of an outside, third-party credentialing provider. One well-known and often-used provider is VCS, Inc. (www.vcsdatabase.com).

These credentialing providers require vendors to register with them so that the provider (instead of the health care facility) performs at least the same credentialing the health care facility would, but the credentialing is done off-site from the health care facility and in a manner that each individual vendor's credentials are investigated, verified against the credentials mandated by each pertinent/participating health care facility, and stored for future use, updating, and network access by the credentialing provider. After a vendor is approved, the credentialing provider gives the qualified/credentialed vendor a badge that typically contains a bar code and possibly other identifying information (such as a photograph), which the vendor uses to authenticate himself in two primary respects when he enters a participating health care facility.

First, the bar code on the vendor's badge can be scanned at a kiosk or other scanning facility in the lobby of the health care facility. The kiosk is computer-implemented and possesses either local or networked access to a database maintained by the credentialing supplier, such that the kiosk uses the bar code to identify the vendor and then access and examine the associated vendor's credentials relative to those mandated by the pertinent health care facility. Through this computerized process, the kiosk either approves or denies the vendor's access to the health care facility. This approval process can entail either the printing of an entrance sticker (to be worn by the vendor), open a locked door, or provide other authorized passage.

Second, as mentioned above, while the badge also may provide photo identification, in those instances in which the kiosk prints an entrance sticker, the kiosk also may print an additional code on the sticker. This additional code provides opportunity for on-the-spot verification by facility personnel as an added security measure after the vendor has gained access to the facility.

Problems, however, abound with this credentialing process. Kiosks are expensive to install and maintain, whether by the health care facility or a credentialing provider. Likewise, the computer hardware implemented by the kiosk often quickly becomes outdated, lacks software updates, is susceptible to network interruptions or outages, and/or becomes incompatible with hardware updates at the health care facility or the credentialing provider. Likewise, if a vendor loses his badge he either must endure the disruption of being denied access while he acquires a new badge, or he might circumvent the health care facility's vendor entry requirements, thereby destroying the entire credentialing process and the safeguards afforded thereby.

### SUMMARY

The present invention addresses the disadvantages and drawbacks of current credentialing processes and the apparatuses associated therewith.

As an example, the present invention replaces the traditional prior art, computer-implemented kiosk with a simple scanner-printer combination. The scanner is used to scan a code and the printer then prints an access badge only if the scanner recognizes the code as associated with a vendor who should be permitted access to the facility. The code no longer is one pre-printed on a vendor's badge, but rather is a code the vendor downloads (from a credentialing provider) to his mobile device, or receives automatically from a credentialing provider, prior to attempting to gain access to the pertinent facility. This way, the vendor is required to request a code (or receives it automatically) more contemporaneously with his desire to gain access to a facility, and (consequently) the credentialing provider is able to provide, deny, or suitably issue a code based on a more contemporaneous evaluation of the vendor's credentials.

As indicated, the improved process for determining whether a vendor will be allowed admission to a facility is not performed by the traditional prior art kiosk, where the vendor scans a bar code on his badge and the hardware/software in the kiosk then determines (based on reference to a locally maintained database or its connection to a networked database) whether the vendor should be permitted access. Instead, the improved process is controlled by electronic interactions between the vendor and a credentialing provider, whereby the vendor uses an application on his mobile device to receive from the credentialing provider (either automatically or upon request) admission criteria including, for example, a badge and an electronic code for entry into a particular facility, which the vendor then uses to gain access to the facility.

More specifically, the vendor uses the scanner portion of the scanner-printer combination stationed at the facility to scan the recently received electronic code from his mobile device and, based on the details of the code, the scanner instructs the printer portion of the scanner-printer combination to either print (or not) an access badge for the vendor. Alternatively, if the vendor is to be denied access to the facility for any reason, the credentialing provider may not deliver admission criteria to the vendor's mobile device. As yet another alternative, based on the information conveyed by the received code, limited or conditional access could be provided by an appropriately denoted badge printed by the associated printer. These processes substantially differ from the prior art because the scanner-printer combination need not be computerized (thereby requiring constant updates and maintenance as described above) to provide, for example, local/remote database accesses and/or the requisite prior art data processing operations necessary to process admission protocols.

Variants of the present invention are possible and within the scope of this disclosure, whether expressly identified or not. For example, the credentialing process could be carried out for people (or things such as equipment, drugs, devices, etc.) other than vendors, credentialing could be performed for any industry other than the health care industry, and/or badges could be customized for limited access or as a function of who, what, why, or when access is sought.

### BRIEF DESCRIPTION OF THE DRAWINGS

The accompanying drawings, which are incorporated herein and constitute a part of the specification, illustrate one or more embodiments and, together with the description, explain these embodiments. In the drawings:

FIG. 1 is an assembly diagram of a scanner printer combination for credentialing;

FIG. 2 illustrates an exemplary embodiment of a remote scanner;

FIG. 3 illustrates an exemplary embodiment of a label.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” (or variants thereof) in various places throughout the specification is not necessarily referring to the same embodiment. Further, the particular features, structures or characteristics may be combined in any suitable manner in one or more embodiments.

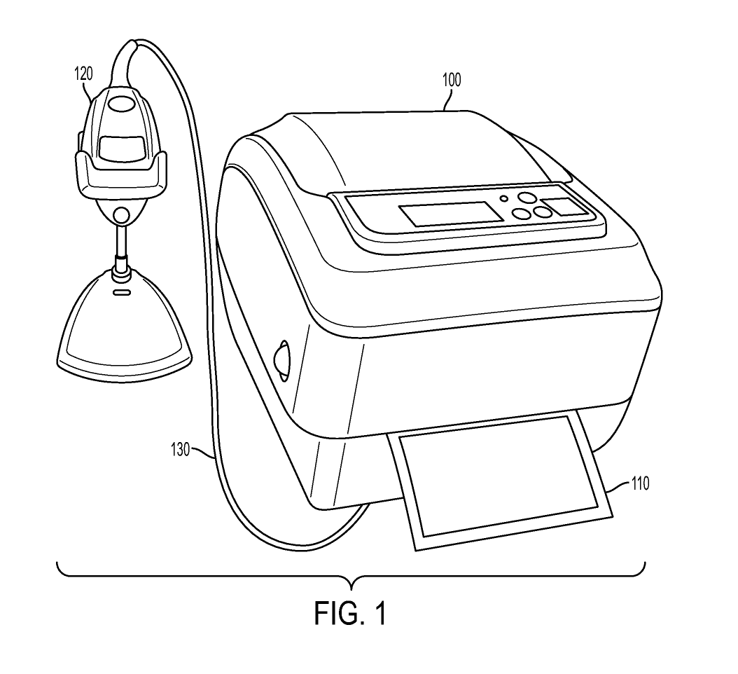

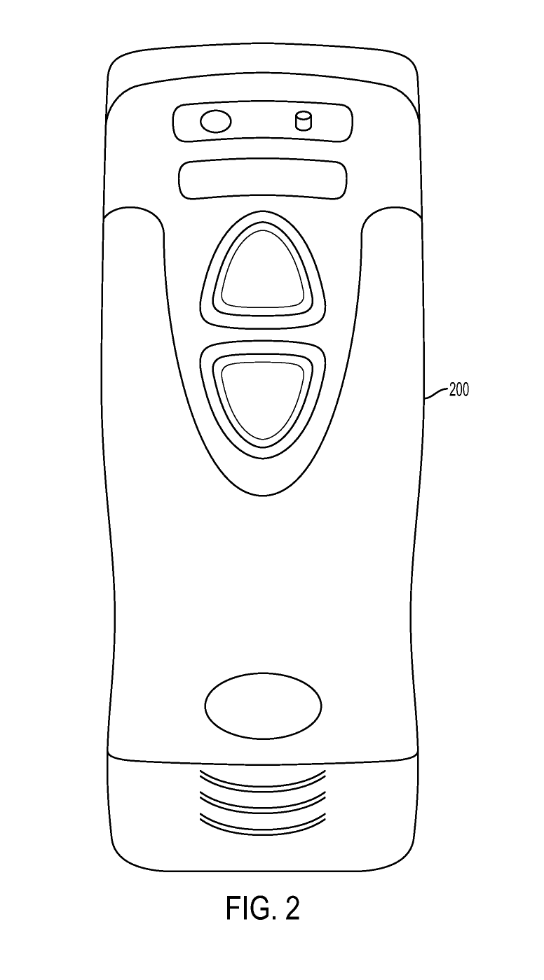

FIG. 1 illustrates an exemplary embodiment of the present invention. As shown, printer 100 is connected to scanner 120 via electrical connection 130. Printer 100 can be for example a DYMO type printer, available from Newell Rubbermaid, Inc., or a G-Series printer available from Zebra Technologies. Scanner 120 can be a scanner commonly available from a number of well-known sources, such as Code Corp. While FIG. 1 shows a wired scanner being used, other embodiments, such as that shown in FIG. 2, may use a wireless scanner 200 to communicate (wirelessly) with printer 100.

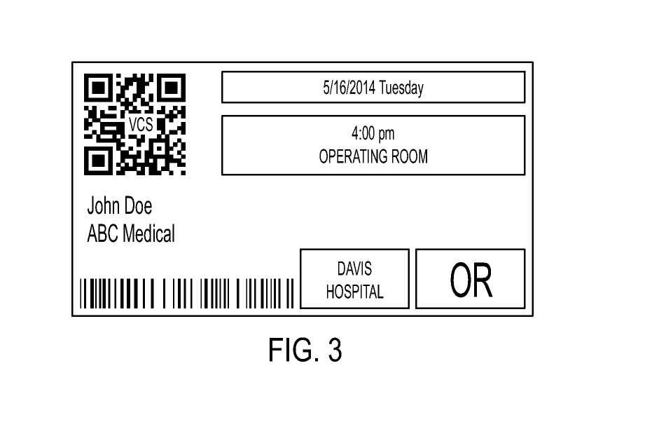

FIG. 1 also shows printer 100 as capable of printing label 110. An example of label 110 is shown in more detail in FIG. 3. As those skilled in the art will appreciate, the informational content of label 110 can be dictated in full or in part by the information transmitted by scanner 120 (or 200) to printer 100, where the information transmitted by scanner 120 (or 200) is in full or in part dictated by a code or other information capable of being read by scanner 120 (or 200).

The apparatus of FIGS. 1-3 can be used for credentialing of any sort. In one embodiment, the apparatus can be used to credential vendors interested in accessing a health care facility. In that embodiment, each vendor first applies to a third-party credentialing provider, which typically includes the vendor providing the credentialing provider with all necessary personal, health, immunization, occupational, background, and like information that the credentialing provider deems necessary to adequately credential the vendor in connection with each health care facility the vendor seeks to enter. The requisite credentialing information also can include an affirmation that the vendor has read and agreed to facility-specific policies and procedures. (Note that various health care facilities typically have different credential requirements, such that the vendor credentials for entering one facility are not the same as the vendor credentials for entering a different facility.)

Once a third-party credentialing provider collects and processes a vendor's credentials, the credentialing provider provides the vendor (or the vendor accesses) a downloadable mobile application that functions to allow the vendor to correspond or interact with the provider via his mobile device (e.g., cell phone, PDA, tablet computer, etc.). The design and/or availability of such mobile applications are well know to those skilled in the art and can be obtained from companies such as Apple, Google, and Microsoft, depending on the application platform.

One such interaction (between vendor and provider via a mobile application) can be the vendor's request for access to a particular health care facility (for which the vendor was previously credentialed by the provider). For example, if the vendor knows he intends to visit “Facility A” that day, he can use the mobile application to identify that facility to the credentialing provider and request that the credentialing provider respond by providing him a form of authorized access to “Facility A”.

The form of authorized access can be, for example, an authorization code such as a bar or QR code electronically transmitted by the credentialing provider to the vendor's mobile device, assuming the credentialing provider first determined that the vendor possessed the appropriate credentials to enter “Facility A”. Of course, if the vendor did not possess the requisite credentials to enter “Facility A”, the provider would respond with a form of “access denied” message, to which the vendor and the credentialing provider could thereafter work together to assess the deficiency in the vendor's credentials for “Facility A”. If the vendor also anticipated visiting “Facility B” that day, he would likewise identify (to the credentialing provider via the mobile application) “Facility B”, and the credentialing provider would respond (based on a comparison of the vendor's credentials with those required by “Facility B”) with either approval (in the form of an electronic authorization code) or disapproval (in the form of an access denied message).

As the foregoing implies, in this particular embodiment, the vendor will receive an access or entry authorization code for entry to each different facility. Upon arrival at a facility, the vendor will approach the scanner-printer combination exemplified by FIG. 1 and use scanner 120 (or 200) to scan the code (on the vendor's mobile device) received earlier as corresponding to that facility. The code embeds information that scanner 120 (or 200) reads and, as appropriate, directs printer 100 to print on label 110. Label 110 can then be worn or otherwise displayed by the vendor, where an appropriately printed and denoted label 110 conveys to the staff and pertinent authorities at the facility that the vendor has cleared that facility's credentialing requirements and is free to enter the facility.

Various permutations of the above-describe exemplary embodiment are possible. For example, without limitation, the mobile application could have additional functionality, such as a location services feature that detects which facility the vendor is presently located in, thereby obviating the need or requirement that the vendor identify the facility he intends to visit. In this scenario, the vendor need only contact the credentialing provider (using the previously-supplied mobile application) and request an authorization code, since the mobile application will already know—based on existing technology well known to those skilled in the art—where the vendor is located and, therefore, which facility he seeks to access. In another scenario, since the location services feature of the mobile application already knows the vendor's location, it may automatically request (via pop-up screen or otherwise on the vendor's mobile device) whether the vendor desires access to that facility. If the vendor responds in the affirmative, then the credentialing process is invoked for that vendor and that facility.

Similarly, as shown in FIG. 3, the authorization code could embed information that, once read by scanner 120 (or 200), is sufficient to instruct printer 100 to print a variety of information on label 110, such as the vendor's name, address, employer, the current day, date, and time, identify the facility and/or locations within the facility the vendor is permitted to visit, specify access privileges, and/or print another code such as a bar or QR code. Due to present limitations on the amount of data that can be conveyed via a scanned authorization code, not all of this information need necessarily be embedded in the authorization code itself, since some of it also could be programmed into the scanner-printer combination to print as part of the process of printing a label when an authorization code is scanned.

In addition to the human readable information printed on label 110, the additionally printed code can be used as a secondary security measure by enabling facility staff to scan it (using an off-the-shelf scanner or an application provided by the credentialing provider) for confirmation that the vendor has indeed met the facility's credentialing protocol and/or to provide additional information about the vendor, the credentialing provider, or other circumstances of the vendor's presence at the facility.

Still further, the vendor's request (to the credentialing provider) for an access or entry authorization code need not necessarily come from the vendor's mobile device running the above-described mobile application. Instead, the vendor could use a non-mobile computing apparatus (e.g., desktop computer, traditional telephone, facsimile) to request an access code from the credentialing provider. The credentialing provider could respond by delivering an authorization code to the vendor's mobile device, by email to the vendor's non-mobile device, by mail or expedited delivery, or other means that allows the vendor to print or otherwise access the authorization code. In either scenario, the received authorization code would then be used in combination with the apparatus in FIG. 1 to gain access to a pertinent facility.

Still further, an embodiment of the present invention includes instances in which the vendor does not have a mobile device but still makes use of the inventive apparatus and process. Specifically, facility staff also can be provided a mobile or desktop application that allows such staff to request authorization (from the credentialing provider) for the vendor. The credentialing provider will respond (as above) with access criteria that can include a code displayed on the staff's mobile or desktop device. That code then can be scanned by the same scanner printer combination described above.

Still further, as yet another embodiment of the invention, the authorization code may embed other information such that, once it is scanned, causes the printer to print label information other than a badge. For example, the printed label could be an expiration label and/or other code that applies to humans or inanimate objects. In other words, the label could designate (either via a printed date or code) that a vendor is to be permitted access until a particular date, or that a product or piece of equipment (to which the label is affixed) expires, requires maintenance, or demands some other attention after a date denoted on the label or the code on the label.

As indicated above, it should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A vendor credentialing method, comprising the steps of:
(a) receiving vendor information;
(b) correlating said vendor information to credentials necessary for entry by said vendor into a facility;
(c) receiving a vendor request for entry into said facility; and
(d) transmitting to said vendor an entry authorization code.

2. The method of claim 1, wherein the vendor request for entry into said facility is received from a vendor's mobile computing device.

3. The method of claim 2, wherein the entry authorization code is transmitted to the vendor's mobile computing device.

4. The method of claim 3 including the step of supplying a scanner-printer combination to said facility, whereby said scanner scans the entry authorization code on the vendor's mobile computing device, transmits data to the printer based on the scanned authorization code, and the printer prints an access authorization label for the vendor based on data received from the scanner.

5. The method of claim 4 wherein the step of receiving a vendor request for entry into said facility is performed contemporaneously with a vendor being in proximity to said facility.

6. The method of claim 1, wherein the vendor request for entry into said facility is received from a vendor's non-mobile computing device.

7. The method of claim 6, wherein the entry authorization code is transmitted to the vendor's non-mobile computing device.

8. The method of claim 7 including the step of supplying a scanner-printer combination to said facility, whereby said scanner scans the entry authorization code, transmits data to the printer based on the scanned authorization code, and the printer prints an access authorization label for the vendor based on data received from the scanner.

9. The method of claim 8 wherein the step of receiving a vendor request for entry into said facility is performed contemporaneously with a vendor being in proximity to said facility.

10. A device credentialing method, comprising the steps of:
(a) receiving device information;
(b) correlating said device information to credentials necessary for entry by said device into a facility;
(c) receiving a request for entry by said device into said facility; and
(d) transmitting an entry authorization code.

11. The method of claim 10, wherein the request for entry by said device into said facility is received from a mobile computing device.

12. The method of claim 11, wherein the entry authorization code is transmitted to a mobile computing device.

13. The method of claim 12 including the step of supplying a scanner-printer combination to said facility, whereby said scanner scans the entry authorization code, transmits data to the printer based on the scanned authorization code, and the printer prints an access authorization label for the device based on data received from the scanner.

14. The method of claim 13 wherein the step of receiving a request for entry by said device into said facility is performed contemporaneously with a device being in proximity to said facility.

15. The method of claim 10, wherein the request for entry by said device into said facility is received from a non-mobile computing device.

16. The method of claim 15, wherein the entry authorization code is transmitted to a non-mobile computing device.

17. The method of claim 16 including the step of supplying a scanner-printer combination to said facility, whereby said scanner scans the entry authorization code, transmits data to the printer based on the scanned authorization code, and the printer prints an access authorization label for the device based on data received from the scanner.

18. The method of claim 17 wherein the step of receiving a request for entry by said device into said facility is performed contemporaneously with said device being in proximity to said facility.

19. A credentialing method, comprising the steps of:
(a) receiving credential information;
(b) correlating said credential information to credentials necessary for entry into a facility;
(c) receiving a request for entry into said facility; and
(d) transmitting an entry authorization code.

20. The method of claim 19, wherein the request for entry into said facility is received from a mobile computing device.

21. The method of claim 20, wherein the entry authorization code is transmitted to the mobile computing device.

22. The method of claim 21 including the step of supplying a scanner-printer combination to said facility, whereby said scanner scans the entry authorization code on the mobile computing device, transmits data to the printer based on the scanned authorization code, and the printer prints an access authorization label based on data received from the scanner.

23. The method of claim 22 wherein the step of receiving a request for entry into said facility is performed contemporaneously with a requestor being in proximity to said facility.

24. The method of claim 19, wherein the request for entry into said facility is received from a non-mobile computing device.

25. The method of claim 24, wherein the entry authorization code is transmitted to a non-mobile computing device.

26. The method of claim 25 including the step of supplying a scanner-printer combination to said facility, whereby said scanner scans the entry authorization code, transmits data to the printer based on the scanned authorization code, and the printer prints an access authorization label based on data received from the scanner.

27. The method of claim 26 wherein the step of receiving a request for entry into said facility is performed contemporaneously with a requestor being in proximity to said facility.
